(19) United States
(12) Patent Application Publication
(10) Pub. No.: US 2007/0284889 A1
(43) Pub. Date: Dec. 13, 2007

(54) RAILROAD TRACK DE-ICING METHOD AND APPARATUS

(76) Inventor: Carlton Leslie, Downers Grove, IL (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/423,272

(22) Filed: Jun. 9, 2006

(51) Int. Cl. B60B 39/00

(52) U.S. Cl. 291/2

(57) ABSTRACT

A system for deicing a railroad portion, such as a switch point, switch plate, or length of rail, including a reservoir of deicing fluid, a deicing fluid dispensing assembly connected in hydraulic communication with the reservoir, at least one ice sensor positioned to report the temperature of the predetermined portion of the railroad system, and a deicing fluid flow actuator operationally connected to the reservoir. Energization of the flow actuator urges deicing fluid through the fluid dispensing assembly and onto the railroad portion.

### CROSS-REFERENCE TO RELATED APPLICATIONS

The present application is a utility application claiming priority to, and based upon, co-pending U.S. patent application Ser. No. 11/125,986, filed May 10, 2005, which claims priority to then co-pending U.S. Provisional Patent Application No. 60/569,524, filed May 10, 2004 and to co-pending U.S. patent application Ser. No. 11/021,448, filed Dec. 23, 2004 and claiming priority to then co-pending U.S. patent application Ser. No. 10/238,451, filed Sep. 10, 2002, now abandoned, and claiming priority to then-co-pending U.S. patent application Ser. No. 09/633,390, filed Aug. 7, 2000, which issued on Sep. 10, 2002 as U.S. Patent No. 6,446,754.

### TECHNICAL FIELD OF THE INVENTION

The invention relates generally to the field of rail transportation and, specifically, to a method and apparatus for deicing railroad tracks.

### BACKGROUND OF THE INVENTION

The formation of ice and the accumulation of snow on railroad track components, such as switches, can cause significant operating problems. Historically a common method of addressing this has been through the use of heat, typically applied as a gas-fired flame, manually invoked and because of this manual initiation, running continuously once invoked. This is inefficient for several factors. First a determination as to the need for de-icing has to be made, usually subjectively. Second a manual step of causing the ignition of these ‘heaters’ has to be accomplished. Third, because of the brute force method of heating much of the energy used is simply dissipated away rather than being used more completely on the need-affected area. Forth, because of the manual steps needed to ignite these different areas the flames are often left running when the need is not currently present but may recur within a time frame soon enough to make the on/off cycle costly to employ. Alternatively, the use of electric resistance heating in lieu of gas-fired flame can be employed but some of the same inefficiencies still exist.

Alternately, the use of chemical antifreeze or deicing agents to prevent the buildup of ice and snow over and around railroad switches has met with some success. Such agents are typically manually applied to problem areas, such as by men with hand-held sprayers. This technique is typically applied to address acute problems, such as already-stuck switches that have already caused problems and will have to be ‘picked’ open, and as such is reactive in nature. This technique suffers the drawbacks of being time consuming, since the laborers must be called, equipped, and sent to the problem areas in response to weather conditions once those conditions have arisen and been identified. Such a response is inefficient in terms of both time and expense lost.

Thus, there remains a need for an efficient and quick mechanism for preventing ice and snow buildup on railroad structures, such as rail, switches and the like. The present invention addresses this need.

### SUMMARY OF THE INVENTION

The present invention relates to a process for sensing the temperature/humidity/dew point and other factors needed for determining if de-icing of railroad track components is required and then automatically causing selective de-icing of these components is described.

One object of the present invention is to provide an improved method and apparatus for preventing the buildup of ice and snow on railroad tracks and equipment. Related objects and advantages of the present invention will be apparent from the following description.

### BRIEF DESCRIPTION OF THE DRAWINGS

FIG. 1 is a schematic view of the tracks of a yard rail system.

FIG. 2 is a top view of the nozzles of a dispensing system for dispensing lubricant positioned on a track in the yard system shown in FIG. 1.

FIG. 3 is a schematic side view of the nozzles and dispensing system shown in FIG. 2 with the wheel of a railroad car rolling thereon.

FIG. 4 is a schematic diagram of the feedback system for controlling the dispensing of lubricant through the nozzles shown in FIG. 2.

FIG. 5 is a schematic view of a lubricating system for the switch plate of a switch.

FIG. 6 is a schematic view of an automated railroad portion deicing system according to a second embodiment of the present invention.

FIG. 7 is a schematic view of the embodiment of FIG. 6 as deployed at a railroad switch plate.

FIG. 8 is a schematic diagram of the control system for dispensing the deicer for the embodiment of FIG. 6.

FIG. 9 is a schematic diagram of a railroad tie housing for the embodiment of FIG. 6.

### DETAILED DESCRIPTION OF THE PREFERRED EMBODIMENTS

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

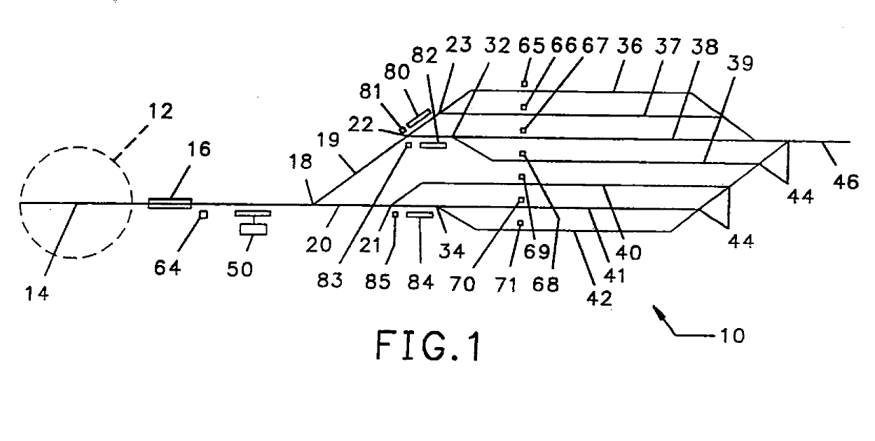

Referring to FIG. 1, a typical yard track system 10 has a hump 12, across which is a feeder track 14. Feeder track 14 passes a first retarder 16 after which there is a first switch 18 for dividing the track 14 into two tracks 19, 20. Following the first switch 18 are secondary switches 21, 22, 23, and following the secondary switches 21, 22, 23 are secondary retarders, now shown. Following the secondary retarders are further switches 32, 34 which ultimately breaks the lines down to yard tracks 36, 37, 38, 39, 40, 41, 42. At the far end of the yard is a second plurality of switches 44 leading to an exit lead 46 across which the assembled trains are withdrawn. An incoming train is broken up by releasing cars over the hump 12 and allowing them to roll down the feeder track 14 and into the yard tracks 36-42.

The retarder 16 tyically has a computer (not shown) that receives input from a speed detector (not shown) and from a scale (not shown) that categorizes the weight of the car. Using these two pieces of information and a look-up table stored in its memory, the computer may adjust the resistant force applied by the retarder 16 to the wheels of the car. If a railroad car is not defective, the car will be moving at the optimum speed when it leaves the retarder and it will move at a predictable speed down track to its destination provided the track has been properly lubricated. On the other hand, if the car is defective, such as because the brake is being applied when it shouldn't be applied, because the bearings of the wheels are worn, or the like, the car will leave the retarder at a significantly slower speed than the optimum speed and its progress as it moves through the yard will be noticeably below the predicted speeds.

It should also be appreciated that a defective car (i.e. a car having the brake applied when it shouldn't be applied, having worn wheel bearings or the like) will leave the retarder at a significantly slower speed than the optimum speed and the noticeably slow moving car can be detected and identified by the first sensor 64. A defective car will also move through the system at a noticeably slower rate of speed. Defective cars are therefore identifiable by their reduced speed after leaving the retarder.

When an entire train is assembled on a yard track, the switches 44 at the output end of the bowl are reconfigured to withdraw the assembled train out the exit lead 46.

Referring to FIGS. 1 through 4, a lubricating station 50 is located behind the first retarder 16 on the feeder track 14. The lubricating station 50 has a supply tank 52, a pump assembly 54 for ejecting the lubricant in the supply tank 52, a motor 56 for operating the pump assembly 54, and a network of feeder lines 58 for directing lubricant to lubricant dispensing member 60. The lubricant dispensing member 60 is typically one or more nozzles, and is more typically an array of nozzles or a blade. An electronic controller or microprocessor 62 controls the operation of the motor 56 and thereby regulates the discharging of lubricant through the nozzles 60. The microprocessor 62 receives input from a first sensor 64 which detects the speed of a car approaching the lubricating station 50 and from a plurality of secondary detectors 65, 66, 67, 68, 69, 70, 71, each of which is typically positioned on one of the yard tracks 36, 37, 38, 39, 40, 41, 42 respectively.

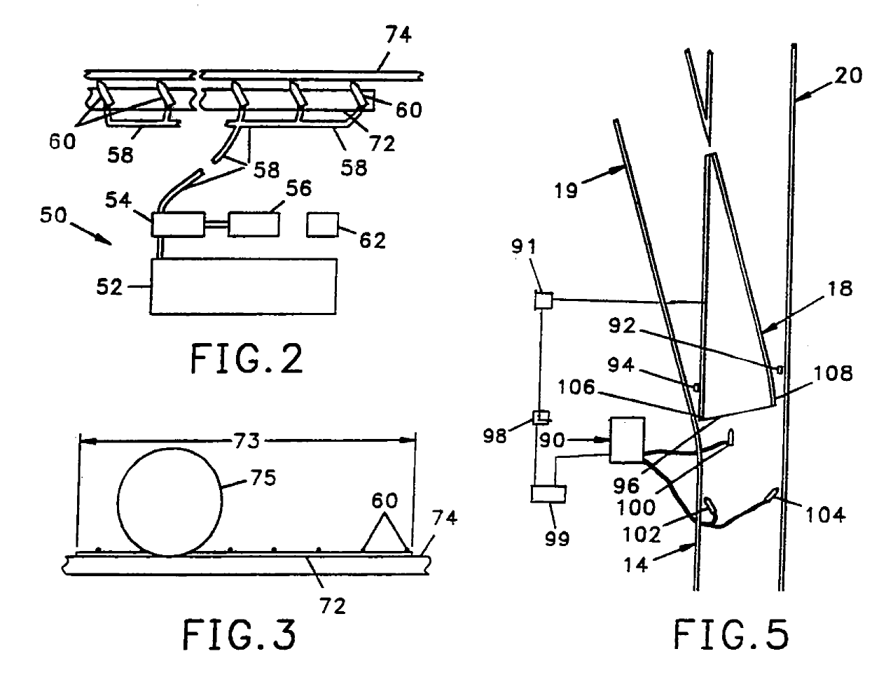

As seen in FIGS. 2 and 3, the dispensing system typically includes two mounting bars 72, one positioned along the inner surface of each of the rails of a track 74. Positioned along the length of each of the mounting bar 72 are the nozzles 60 which are of a type known in the art for dispensing lubricants. Each mounting bar 72 has a length 73 which is approximately equal to the circumference of a typical rail car wheel 75 so that lubricant dispensed through the nozzle 60 on the mounting bar 72 will lubricate the entire circumference of the wheel 75 as it rolls across the lubricated portion of track 74. The wheels of the railroad car will then transport the lubricant down the feeder track 14 to the selected yard track into which the car is directed.

Nozzles 60 are typically positioned sufficiently close to one another and that the pump assembly 54 eject an adequate amount of lubricant on each application to apply a continuous path of lubricant along the entire length 73 of the track 74. It should be noted that the viscosity and other properties of the lubricant change with temperature; thus, the amount of lubricant being applied by the nozzles 60 may be temperature dependent in some pump systems. Thus, the pump assembly 54 should be adapted to supply a constant amount of lubricant independent if the temperature of the lubricant, pump assembly 54 and/or tracks such that the desired amount of lubricant will be ejected through the nozzles 60 on each application. One type of pump assembly 54 adequate for the job is a positive displacement pump. Another type of pump assembly 54 adequate for the job is a lubricant reservoir located such that it is pressurized by the displacement of the tracks as the train passes over them and connected to the nozzles 60 via solenoid switches (not shown) wherein the switches are controlled by the microprocessor 62.

It is desirable that the lubricant be evenly applied along the length 73 of the track 74, however, the nozzles 60 of a dispensing system can become damaged from debris carried by the moving cars or the like. Damaged nozzles may partially restrict the flow of lubricant passing therethrough, and if they are all linked together they may not dispense the lubricant evenly on the track. To insure that the lubricant is evenly applied along the length 73 of the mounting bar 72, each nozzle 60 has an associated valve 76. The valves 76 are sequenced, such that each valve 76 is successively independently opened. All the lubricant dispensed by the pump assembly 54 will then pass through only one nozzle at a time thereby insuring that the nozzle 60 all dispense an equal amount of lubricant.

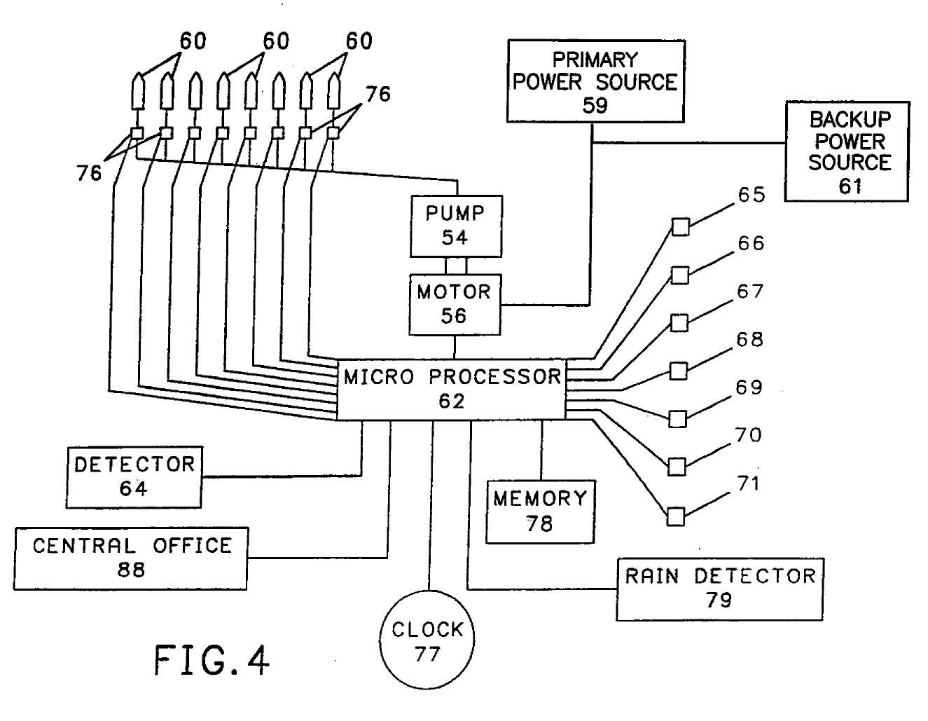

Referring further to FIGS. 1 and 4 as a moving railroad car reaches the associated yard track 36, 37, 38, 39, 40, 41, 42, it will pass over the associated detector 65, 66, 67, 68, 69, 70, 71, which will send a signal to the microprocessor 62 designating the arrival time of the car. The microprocessor 62 includes a clock 77 and a memory 78, and the microprocessor 62 will divide the time that has elapsed from when the car crossed the first detector 64 to when it arrived at the secondary detector by the distance traveled to calculate an average speed for the car. If the average speed of a car entering a yard track 36-42 is below a predetermined desired speed stored in the memory 78 of the microprocessor but not excessively slow, the microprocessor 62 will direct power to the motor 56 for operating the pump assembly 54 and apply lubricant to the track when the wheels 75 of the next railroad car approaches the station 50. If the microprocessor 62 determines that the cars are rolling at the desired speed, it will not direct power to the motor 56 when the next railroad car approaches thereby controlling the further lubrication of the tracks.

The microprocessor 62 is also responsive to a rain detector 79 which detects when the tracks in the system are being lubricated by rain or snow. It is not necessary to lubricate wet tracks because water is an adequate lubricant. Accordingly the computer 62 is programmed to ignore readings from the detectors while the rain detector indicates the tracks are wet. The rain may, however, wash lubricant off the tracks, and therefore the computer 62 will initiate new calculations to determine track lubrication as soon as the tracks dry. The microprocessor 62 will therefore energize the motor 56 on information detected after the tracks have dried that show that cars are moving below the desired speeds. The microprocessor will also detect the presence of a potentially defective railroad car and notify the central office 88 as is further described below.

Referring to FIG. 1, the invention further includes secondary lubrication stations 80, 82, 84 positioned after switches 18, 21, and 22 and prior to switches 23, 32, and 34. Each of the secondary lubrication stations 80, 82, 84 has a supply tank, a motor, a pump assembly, nozzles and a microprocessor (all not shown) as described with respect to the primary lubrication station 50, and has a detector 81, 83, 85 respectively, associated therewith. Like the first detector 64 of the primary station 50, the detectors 81, 83, 85 of the secondary stations 80, 82, 84 are positioned immediately before the associated secondary station and signal the station when a railroad car is approaching. Each secondary lubrication station 80, 82, 84 receives additional input only from the detectors which are located down track of the station. That is, station 80 receives input only from detectors 65, 66, station 82 receives input only from detectors 67, 68, and station 84 receives input only from detectors 70, 71.

The secondary stations 80, 82, 84 provide lubrication to only a portion of the track system 10 and not to the entire system as does the primary station 50, and are activated only after the computer 62 of the primary lubricating station 50 determines that the access tracks are already adequately lubricated. For example, if a number of cars have been directed down tracks 14 and 19 to yard tracks 65 and 66, the entire length of this portion of the system will have become lubricated as a result of the lubricant dispensed from the primary station 50. The cars directed to yard tracks 65 and 66 would then be rolling at the desired average speed and the station 50 would not be applying lubricant to the racks. If cars are subsequently directed to yard tracks 67 and 68, and these cars are found to have an average speed less than the desired speed, the loss in speed would presumably be due to inadequate lubrication of yard tracks 67 and 68. In this event the microprocessor 62 of the primary station 50 will not direct power to the motor 56 to further lubricate the tracks. The microprocessor of the secondary station 82, however, will measure the time required for a car to pass from the detector 83 associated with the station 82 to the down track detectors 67 and 68. If this microprocessor determines that these cars are not moving at the desired speed, it will direct power to the associated motor and the secondary station 82 will commence lubricating the tracks prior to the passing of each railroad car. The secondary station will continue to dispense lubricant to the tracks until the cars are again rolling at the desired speed, after which the secondary station 82 will stop lubricating the tracks prior to the passage of a railroad car.

As can be seen, the present invention provides feedback from down track of the speed of the railroad car. Where the speed of the car is below a predetermined speed, the lubricating stations 50, 80, 82, 84 will dispense lubricant on the track 74 immediately before the arrival of the next railroad car. The rolling cars will pick up the lubricant on the wheels thereof and apply it to the track as they move. The system will continue to dispense a fixed amount of lubricant on the tracks prior to the passing of a railroad car until the microprocessors 62 of the various stations determine that the cars are rolling at speeds consistent with lubricated tracks, after which the microprocessors 62 will terminate the dispensing of lubricant.

Referring to FIG. 4, a feature of the present invention is that it will identify potentially defective cars. It is far more expensive to deal with a defective car after it has been incorporated into a moving train than to repair the car while it is still in a yard.

When the microprocessor determines that a car passing the detector 64 is moving at either an excessively high speed or an exceptionally slow speed, the microprocessor 62 of the various stations 50, 80, 82, 84 will identify the car as defective and will not energize the associated motor 56 to eject lubricant on the tracks in the path of the car. The microprocessor 62 will also ignore all information from the various sensors triggered by the car in determining whether lubrication is needed for succeeding cars thereby avoiding erroneous information into its calculations. Finally, the microprocessor will notify the central office 88 of an exceptionally slowly moving car which may be defective.

Referring to FIG. 5, the invention further includes a lubrication station 90 positioned at each switch 18, 21, 22, 23, 32, 34 of which switch 18 is exemplary of all such switches. The switch plates and the switch points of a railroad system are especially subject to wear, but currently, no effort is made to apply lubricant to these portions of existing yard systems. There is also a need to lubricate the switches that are not part of a yard system.

The lubrication station 90 includes a reservoir, a positive displacement pump, a motor and a microprocessor (none of which are shown) similar to those discussed with respect to primary lubricating station 50. The lubrication station 90 also has first and second detectors 92, 94 for detecting whether the switch plate 96 of the switch 18 is locked to direct a moving car down track 19, or is locked to direct a moving car down track 20. Station 90 also has a primary lubricating nozzle 100 aimed to direct lubricant onto the switch plate 96 and secondary nozzles 102 and 104 to direct lubricant to the tops of the rails a short distance before the switch points 106, 108.

Preferably the secondary nozzles are positioned to direct a flow of lubricant at a point on top of the track that precedes the switch point by a distance approximately equal to the circumference of the wheel of a railroad car. When lubricant is dispensed to the top of a track, the lubricant will be picked up on the wheels of the next passing railroad car. Where the lubricating point precedes the switch point by approximately the circumference of a wheel, the wheels of the next passing railroad car will go through one revolution after when they will transfer some of the lubricant thereon to the surface of the switch point thereby lubricating the switch point.

A logic device, which may be a microcomputer, initiates the operation of the pump to direct lubricant from the reservoir to the nozzles 100, 102, 104 when the detectors 92, 94 detect that there is movement of the switch plate 96. The lubrication station 90 will, therefore, lubricate the switch plate 96 and the switch points 106, 108 of switch 98 each time the switch is thrown.

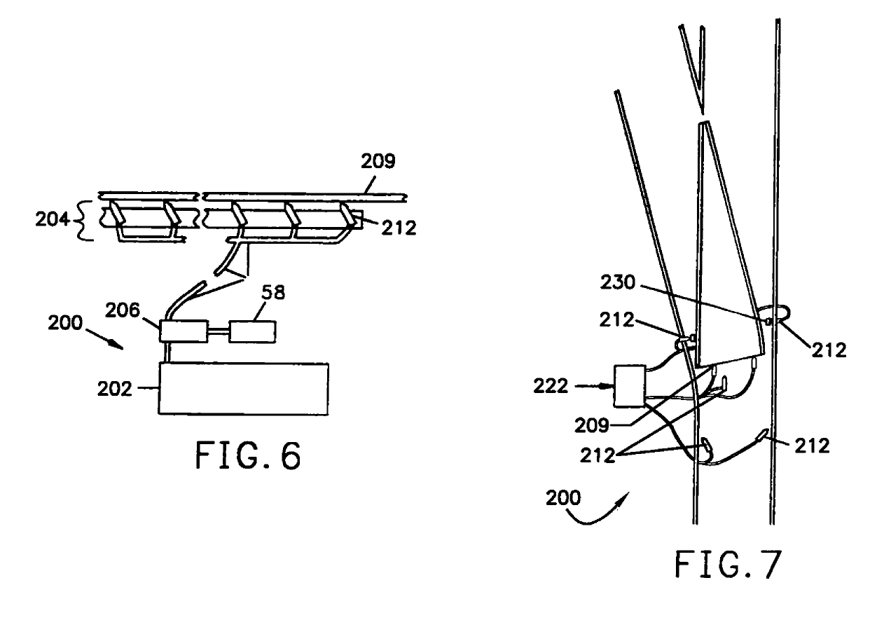

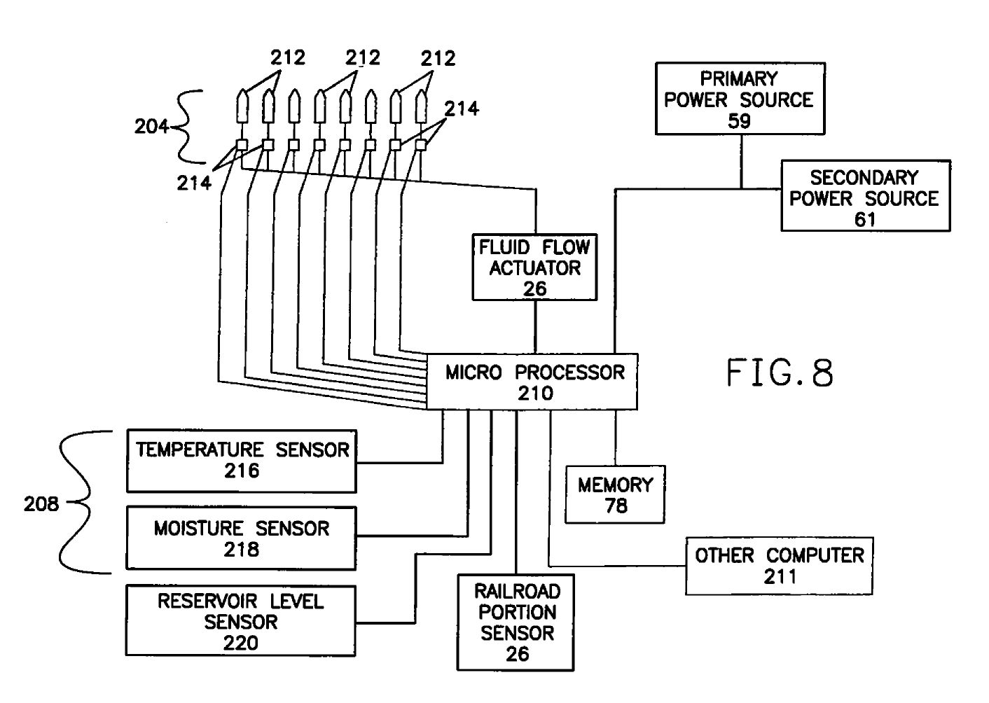

Much of the above structure for automatic track lubrication may be readily adapted to address the issue of railway deicing. FIGS. 6-9 relate to another embodiment of the present invention, a railway deicing system 200 for the automation of chemical railway deicing techniques, such as those employed in aircraft operation and manual track applications. As used herein, the language ‘deicing’ encompasses not only the removal of preexisting ice/snow, but also the prevention of the accumulation of ice/snow. The system 200 includes a reservoir of deicing fluid 202, a deicing fluid dispensing assembly 204 connected in hydraulic communication with the reservoir 202, and a deicing fluid flow actuator 206 operationally connected to the reservoir 202. The system 200 also typically includes at least one ice sensor 208 positioned at or near a portion of the railroad system 209 desired to be deiced or kept free of ice to report the temperature thereof. The portion of the railroad system 209 to be deiced may be a length of track, a length of rail, a switch, a switch plate, a derail, switch rods and stands, walkways, or the like.

The system 200 further includes a microprocessor 210 connected in electric communication with the sensor 208 and the deicing fluid flow actuator 206. The microprocessor 200 is typically adapted to receive electrically communicated information, and more typically electric communication includes the reception of radio frequency (RF) signals. In other words, the microprocessor 210 is typically capable of wireless communication. More typically, the system 200 includes at least one valve 214 operationally connected to the deicing fluid dispensing assembly 204 and connected in electric communication with the microprocessor 210. Still more typically, the microprocessor 210 is electrically connected to another computer 211, which is typically a central computer 211 tasked with coordinating several such microprocessors 210. Further, remote intervention such as activation, status and/or alarm monitoring may be employed from devices in electric communication such as microprocessors, laptop computers, personal digital assistants (PDAs), cellular telephones, CE devices, or the like.

The deicing fluid dispensing assembly 204 may be of a blade type or may comprise one or more nozzles 212. More typically, the deicing fluid dispensing assembly 204 includes an array of nozzles 212. The nozzles 212 are typically positioned sufficiently close to one another such that, when energized, the deicing fluid flow actuator 206 may supply an adequate amount of deicing fluid to the deicing fluid dispensing assembly 204 to apply a continuous path of deicing fluid to the railroad portion desired to be deiced. It should be noted that the viscosity and other properties of the deicing fluid may change with temperature; thus, the amount of deicing fluid being supplied by the deicing fluid flow actuator 206 may be temperature dependent in some system configurations. Thus, it is preferable that the deicing fluid flow actuator 206 be adapted to supply a constant amount of deicing fluid independent of the temperature of the deicing fluid, deicing fluid flow actuator 206 and/or railroad portion such that the desired amount of deicing fluid will be ejected through the deicing fluid dispensing assembly 204 on each application.

One type deicing fluid flow actuator 206 adequate for the job is a positive displacement pump. Another type of deicing fluid flow actuator 206 adequate for the job is a pressurizer operationally connected to the reservoir 202 such that the reservoir 202 is substantially constantly pressurized and connected to the deicing fluid dispensing assembly 204; in this configuration, one or more solenoid valves 214 are connected to the fluid dispensing assembly (in the case of a plurality of nozzles 212, a solenoid valve 214 may be connected to each respective nozzle 212 or to a group of nozzles 212) and to the microprocessor 210 such that the valves 214 are selectively and independently controlled and sequenced by the microprocessor 210. Alternately, the pressurizer 206 may be a movable tie that can provide pressurization to the reservoir 202 by transducing the displacement of the tracks as the train passes over them.

The ice sensor 208 may be a unitary sensor for detecting frozen water or may be a combination of a temperature sensor 216 and a moisture sensor 218. Typically, a number of ice sensors 208 are deployed on or near the railroad portions 209 desired to be kept free of ice buildup. More typically, the ice sensor 208 includes an RF transmitter in wireless communication with the microprocessor 210. Typically, the system further includes a reservoir level sensor 220 (connected in electric communication with the microprocessor 210) for measuring the deicing fluid level remaining in the reservoir 202

The deicing fluid filling the reservoir 202 is typically chosen from formulas known in the art, such as the NASA/AMES developed ICE FREE SWITCH® (registered to Midwest Industrial Supply, Inc., P.O. Box 8431, Canton, Ohio, 44711) or any convenient deicing/antifreeze liquid or composition.

Thus, through the use of appropriately placed sensors 208, 216, 218, computer 210 monitoring and control, wireless communication to the selected de-icing components/locations and the use of a deicing fluid, the entire system 200 may be automated with metered application according to need. Depending on temperature variables, the system 200 could also use other deicing products. This allows for selective use from both a location and duration standpoint, thus significantly reducing unnecessary or excessive application of deicing fluid and resulting in the deicing process to be reliably available without subjective assessment and the need for human intervention.

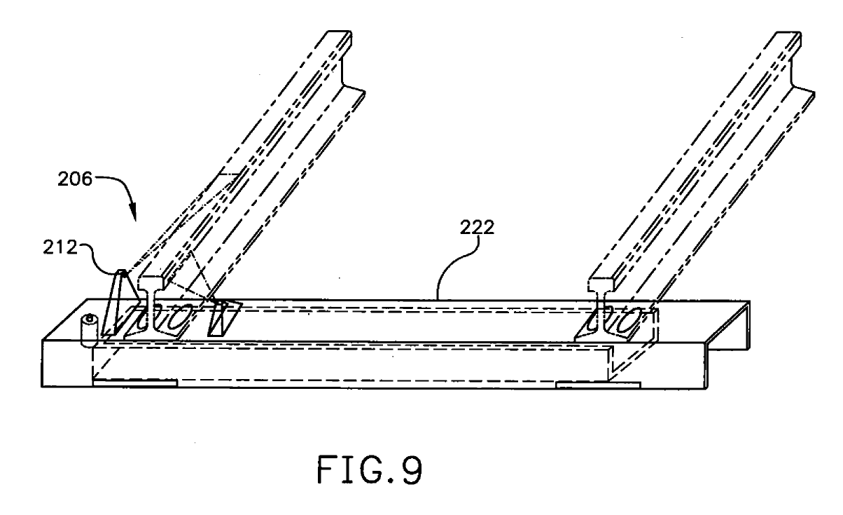

Typically, the system 200 includes a plurality the above-described reservoir 202, deicing fluid dispensing assembly 204, deicing fluid flow actuator 206, ice sensor 208 and microprocessor 210 combinations as described above, located in substations 222 distributed near railroad portions 209 identified as requiring occasional deicing and connected via the central computer 211. Each substation 222 may include utility building to house the appropriate system 200 components. Alternately, a substation 222 may include a partially hollow railroad tie to house the appropriate system components. (See FIG. 9). Still alternately, while the substation 222 is typically supplied with electric power a main power source 224, such as via power lines, the substation 222 may also include a second power source 226, such as a generator, a battery, a solar collector, or the like, to provide uninterrupted power in the event of a main power failure.

### Operational Flow

Since forecasts of weather conditions are general to an area that may be too large for reliably defining specific location needs, the system 200 employs sensors 208, 216, 218 typically located to define conditions at the actual served substations 222. This data is wirelessly available to a central computer 211 that frequently polls each substation 222 and processes this information against an algorithm that defines the need for de-icing on a substation 222—by—substation 222 basis. When a railroad portion 209 associated with a substation 222 meets criteria for de-icing, the microprocessor 210 electrically, and typically wirelessly, activates the energization of the deicing fluid flow actuator 206 to dispense deicer fluid to the specified track component 209 according to that components pre-defined quantity and frequency of application until the sensors 208, 216, 218 report that deicing is no longer indicated. Additionally, each substation 222 typically includes has a ‘low material’ indicator 220 that will cause an alarm condition at the central computer 211 indicating the need for refilling the reservoir(s) 202 at the different substation 222. This is a redundant safety factor since the central computer 211 typically also calculates the deicing fluid usage and schedules refilling of the reservoirs 202 accordingly. The central computer 211 and microprocessors 210 also will monitor the respective system 200 devices and call for the repair of any components identified as defective.

### Apparatus Hardware and Software

The deicing system 200 typically consists of the following components at each serviced location 222: a fluid storage reservoir 202, pump 206 and spray nozzle array 204 to dispense the de-icier, sensors for ice 208, moisture 218, track temperature 216, fluid level 220, railroad portion disposition 230 (i.e, switch position or the like), a wireless data transceiver and logic control unit 210, and a trackside enclosure 222 or specially constructed rail road ‘tie’ 222 to house the above-mentioned components. The basic control system 232 functionally includes wireless and wired networking components 210, 211 (including the microprocessor 210 and central computer 211), programming loaded into the components 210, 211 to monitor, control and activate, report on and maintain records of the operation of serviced location components 202, 204, 206, 208 and the like, monitoring equipment and sensors 208 that may be polled for weather data, and selectable algorithms for deicing need determination and control. Other parameters that may be monitored by the microprocessor 210 are switch alignment, car counts, car movement/timing, wheel counts, barcodes, switch actuation and position, and the like, provided appropriate sensors are appropriately positioned and connected in electric communication to the microprocessor 210.

While the system 200 typically uses the 802.11G wireless networking protocol, the control and monitoring and the communication paths are not limited to this wireless modality and could use almost any wireless connectivity (not limited to RF) or be hard wired with normal computer network wiring, such as coax, Cat. 5 or 6, fiber, and the like.

### Operating Power

Main power 224 for the system 200 typically comes from the local grid via electrical power lines. Typically, a secondary power source 226 is provided, such as a back-up generator, a photovoltaic/storage battery power supply, or the like, may be added to establish an uninterrupted power source. Where more power is needed, perhaps for actual switching operation, an energy recovery system is described here. This system could be used for multiple applications not limited just to deicing or switching, but for things such as track lubrication and track crossing lights and/or gates at locations where the supply of normal electrical power distribution would be difficult or expensive. Further, on a larger scale this system could be used to augment commercial power and through time and cost amortization become a true co-generation system recovering ‘waste’ energy from the actual train operation.

### Energy Recovery System

There are many locations where rail tracks are frequently used by long and heavy trains. Due to the nature of the track construction there is a significant track deflection as each set of wheels roll by. Further, many of these locations (e.g., hump yards and switching centers) have electrical energy requirements of their own. This deflection may be transduced to provide useful ‘found’ energy.

There are at least three methods of capturing this energy. A series of hydraulic cylinders placed in specially constructed ‘ties’ and connected with the output fluid being transmitted via tubing to a hydraulic motor/flywheel assembly with check valves and fluid return tubing would cause this deflection to be converted into rotary energy that would be able to drive a generator.

A second method would substitute a magnetic plunger traveling through a wire coil such that direct generation of electricity would result and through pooled wiring and diode isolation this electricity can be conditioned with a solid-state inverter/frequency synthesizer to be directly utilized.

A third method (possibility used in conjunction with one of the above methods) would be to attach piezoelectric transducers thus capturing higher frequency vibrations in addition to the mechanical deflection. (This might also be practical in a highway roadbed as a stand-alone method).

Due to the variety of power requirements in this system and the loads to be served both alternating and direct current components can be used as efficiencies dictate.

### Energy Transfer

In order for this type of energy recovery system to be practical, the electrical energy resultant from it would preferably be used locally (saving retail dollars) or connected to the utility grid (yielding wholesale dollars). One alternative would be through a storage system, which would likely be less cost efficient, unless used at a location that did not have economical access to commercial power such as a rural crossing gate, an isolated switch or a communications repeater site, etc.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

What is claimed is:

1. A method of deicing a predetermined portion of a railroad system, comprising:
filling a reservoir with deicing fluid;
operationally connecting a deicing fluid dispensing assembly to the reservoir;
positioning at least one temperature sensor in thermal communication with a predetermined portion of the railroad system;
connecting a pump connected in hydraulic communication to the reservoir and the deicing fluid dispensing assembly for dispensing a predetermined quantity of deicing fluid through the dispensing assembly;
operationally connecting a microprocessor operationally connected to the pump and to the temperature sensor;
positioning the deicing fluid dispensing assembly adjacent the predetermined portion of the railroad system to provide a substantially continuous stream of deicing fluid onto the predetermined portion of the railroad system when the predetermined quantity of deicing fluid is dispensed;
wherein the microprocessor actuates the pump to provide a substantially continuous stream of deicing fluid onto the predetermined portion of the railroad system in response to a signal from the at least one temperature sensor below a predetermined temperature threshold.

2. The method of claim 1 and further comprising:
positioning a first detector adjacent a predetermined section of track for generating a first detector signal in response to a railroad car crossing the predetermined section of track;
operationally connecting the first detector to the microprocessor;
wherein the microprocessor actuates the pump to dispense deicing fluid through the fluid dispensing assembly in response to the first detector signal and a signal from the at least one temperature sensor below a predetermined temperature threshold.

3. A method of deicing the switch plate of a railroad switch where said switch plate is moveable between a first position in which said switch will direct a rolling railway car to a first track and a second position in which said switch will direct a rolling railway car to a second track, said method comprising the steps of:
providing a temperature sensor for generating a signal in response to the temperature of the switch plate;
providing a moisture sensor for generating a signal in response to the presence of moisture on the switch plate;
providing a memory operationally connected to the temperature sensor and the moisture sensor;
recording in the memory a predetermined temperature threshold;
automatically comparing the temperature of the switch plate as shown by the temperature sensor to the predetermined temperature threshold in the memory;
providing a system for dispensing deicing fluid to the switch plate in response to the temperature of the switch plate falling below the predetermined temperature and to the presence of moisture on the switch, wherein the system further includes:
a reservoir of deicing fluid;
a deicing fluid dispensing assembly connected in hydraulic communication with the reservoir;
at least one temperature sensor positioned to report the temperature of the predetermined portion of the railroad system; and
a flow actuator for urging deicing fluid from the reservoir through the fluid dispensing assembly and onto the switch plate, the flow actuator being operationally connected to the reservoir and to the fluid dispensing assembly.

4. The method of claim 3 wherein the flow actuator is a pump.

5. The method of claim 3 wherein the reservoir is pressurized and wherein the flow actuator includes a solenoid valve operationally connected to the fluid dispensing assembly and operationally connected to the microprocessor.

6. The method of claim 3 further comprising a fluid level sensor operationally connected within the reservoir and operationally connected to the microprocessor.

7. A system for deicing a railroad portion, such as a switch point, switch plate, or length of rail, comprising in combination:
a reservoir of deicing fluid;
a deicing fluid dispensing assembly connected in hydraulic communication with the reservoir;
at least one ice sensor positioned to report the temperature of the predetermined portion of the railroad system; and
a deicing fluid flow actuator operationally connected to the reservoir;
wherein energization of the flow actuator urges deicing fluid through the fluid dispensing assembly and onto the railroad portion.

8. The system of claim 9 wherein the ice sensor further comprises a temperature sensor and a moisture sensor.

9. The system of claim 9 wherein the deicing fluid dispensing assembly includes an array of nozzles.

10. The system of claim 9 further comprising a solenoid valve operationally connected to the deicing fluid dispensing assembly and wherein the solenoid valve is connected in electric communication with the microprocessor.

11. The system of claim 9 wherein the railroad portion is a switch plate.

12. The system of claim 9 wherein the deicing fluid dispensing assembly further comprises a plurality of nozzles and a plurality of valves, each respective valve operationally connected to a respective nozzle; wherein each respective valve is connected in electric communication with the microprocessor; and wherein the microprocessor is programmed to sequentially open and close the respective valves.

13. The system of claim 9 wherein the deicing fluid dispensing assembly further comprises at least one group of nozzles and at least one valves, each valve operationally connected to a respective group of nozzles; wherein each respective valve is connected in electric communication with the microprocessor; and wherein the microprocessor is programmed to sequentially open and close the at least one valve.

14. The system of claim 9 and further comprising means for manually energizing the deicing fluid flow actuator.

15. The system of claim 9 wherein the deicing fluid flow actuator is a pump.

16. The system of claim 9 wherein the deicing fluid flow includes a pressurizer operationally connected to the reservoir and at least one valve operationally connected to the deicing fluid dispensing assembly, wherein the pressurizer and the at least one valve are connected in electric communication to the microprocessor.

17. The system of claim 9 wherein the reservoir is housed in an at least partially hollow railroad tie.
